(19) United States
(12) Patent Application Publication
(10) Pub. No.: US 2008/0311308 A1
(43) Pub. Date: Dec. 18, 2008

(54) Composition for Functional Coatings, Film Formed Therefrom and Method for Forming the Composition and the Film

(76) Inventors: Hae-Wook Lee, Daegu-City (KR); Jin-Hong Park, Daegu-city (KR)

Correspondence Address: HARNESS, DICKEY & PIERCE, P.L.C., P.O. BOX 8910, RESTON, VA, 20195, US

(21) Appl. No.: 11/659,213

(22) PCT Filed: Aug. 13, 2004
(86) PCT No.: PCT/KR2004/002033

§ 371 Date: Feb. 2, 2007

(51) Int. Cl. C04B 14/00; C08K 5/17; C08J 3/28; C08F 4/32; C08F 2/48; C08L 33/02; C08F 2/54; C08F 2/46; C04B 14/30

(52) U.S. Cl. 427/496; 524/236; 522/40; 522/41; 522/48; 522/53; 522/67; 522/70; 522/43; 522/33; 522/68; 427/521; 427/508; 106/400; 106/401; 524/556; 252/500

(57) ABSTRACT

The present invention relates to compositions for functional films, and more particularly to compositions for functional films such as a heat ray screening film compatible with hydrolic or alcoholic and anti-hydrolic resin binder, a near infrared screening film, a chrominance correcting film, a conductive film, a magnetic film, a ferromagnetic film, a dielectric film, a ferroelectric film, an electrochromic film, an electroluminescence film, an insulating film, a reflecting film, a reflection preventing film, a catalyst film, a photocatalyst film, a light selectively absorbing film, a hard film, and a heat resisting film, films formed therefrom, and a method of forming the compositions and the films.

### TECHNICAL FIELD

The present invention relates to compositions for functional films, and more particularly to compositions for functional films such as a heat ray screening film compatible with hydrolic or alcoholic and anti-hydrolic resin binder, a near infrared screening film, a ceramic color tinting film, a chrominance correcting film, a conductive film, a magnetic film, a ferromagnetic film, a dielectric film, a ferroelectric film, an electrochromic film, an electroluminescence film, an insulating film, a reflecting film, a reflection preventing film, a catalyst film, a photocatalyst film, a light selectively absorbing film, a hard film, and a heat resisting film, films formed therefrom, and a method of forming the compositions and the films.

### BACKGROUND ART

A method of forming functional films formed of various functional materials include a method of using a vacuum process and a method of using a wetting process. The method of using the vacuum process includes a physical vapor deposition method such as a sputtering method, an E-beam deposition method, an ion plating method, and a laser abulation method and a chemical vapor deposition method such as a thermal chemical vapor deposition method, a photochemical vapor deposition method, and a plasma chemical vapor deposition method. The method of using the wetting process includes a deep coating method using sol-gel method and a spin coating method.

However, the method of using the vacuum process requires complicated manufacturing processes and apparatuses to increase manufacturing cost. On the other hand, the method of using the sol-gel method requires a sintering process at a high temperature in most cases to increase manufacturing time. Therefore, there are limitations on manufacturing films. Heat ray screening films will be described among various functional films. Transparent coating films effective to screening heat is advantageous to being associated with means for preventing malfunctions of integrated circuits or electronic components and for preventing forgery of credit cards or means for reducing the cooling and heating costs by reducing the amount of solar energy received from windows to rooms and automobiles. In addition, it is possible to provide effects of screening infrared rays when they are applied to various products such as optical fibers, sun visors, PET vessels, packaging films, glasses, textile goods, peep holes of heaters, and heating apparatuses.

There has been proposed several films capable of transmitting light with the wavelength of 380 to 780 nm in a visible right range while reflecting light with the wavelength of 800 to 2,500 nm around the range of infrared rays, formed by the methods of: (1) forming films with ingredients of tin oxide and antimony oxide by means of a spray process (refer to JP03-103341); (2) forming films of tin-doped indium oxide (hereinafter, referred to as “ITO”) on a glass substrate by means of physical vapor deposition, chemical vapor deposition, or sputtering; and (3) coating a substrate with a near-infrared absorber in the type of organic dyestuffs such as pthalocyannine series, anthraquinone series, naphtoquinone series, cyanine series, naphtaloctannine series, condensed azo polymers, and pyrrol series by means of an organic solvent and an organic binder or transforming the about-infrared absorber into a coating.

However, the method (1) needs a thick film because it has weak performance for screening heat rays, which results in a low transmittance rate for visible light. The method (2) consumes a high product cost because it needs an apparatus with control of the atmosphere in high vacuum and accuracy, being restricted in sizes of coating films and shapes and disadvantageous to implementation due to insufficient mass-productivity. The method (3) is insufficient in advancing the heat screening efficiency because it has a low transmittance rate for visible light and dark colors and is restricted to absorb near-infrared rays with wavelengths 690 to 1,000 nm.

While the methods (1) and (2) are available for screening ultraviolet rays as well as heat rays, they are incapable of receiving electric waves from mobile phones, televisions, and radios because their materials reflect the electric waves due to small surface resistance, i.e., high electrical conductance.

In order to overcome the problems, there have been proposed several techniques disclosed in Japanese Patent NOs. JP56-156606, JP58-117228, and JP63-281837, in which an antimony-doped tin oxide (hereinafter, referred to as “ATO”) is mixed with a resin binder, ATO is directly added to a resin binder dissolved in an organic solvent, and a coating compound manufactured by adding an organic binder and tin oxide nanoparticles into a splittable surfactant is deposited to form a heat ray screening film. However, it still needs a thick film enough to perform an infrared ray screening function, which contains low transmittance rate for visible light to lower the transparency.

On the other hand, Japanese Patent NOs. JP07-24957, JP07-70363, JP07-70481, JP07-70842, JP07-70445, and JP08-41441 disclose a method of manufacturing powders with an excellent performance of screening heat rays by processing or manufacturing ITO nanoparticles in the atmosphere of inert gas and a method of forming a heat screening film formed by mixing organic/inorganic binders with a dispersion sol made from water or an alcoholic solvent without using an organic solvent to screen heat rays over 90% under the condition of wavelength of 100 nm. However, as the ITO nanoparticles is mainly formed of a highly expensive indium and is obtained by performing a secondary process in the atmosphere of inert gas, there are limitations on practical implementation due to the high product cost. Moreover, the ITO nanoparticles cause delamination or cohesion when they are mixed with an ultraviolet-hardening resin binder and are in poor preservation. Japanese Patent NOs. JP09-324144, JP09-310031, JP09-316115, JP09-316363, JP10-100310, and JP12-169765 disclose a method of mixing a dispersion sol of the first heat ray screening nanoparticles and the second heat ray screening compound (the near-infrared absorber or 6-boronic nanoparticles), or mixing respective coating compounds to form a film with an excellent heat ray screening characteristic. However, in this case, a visible ray transmittance rate is remarkably deteriorated or it is not easy to induce dispersion while manufacturing a dispersion sol of the second heat ray screening compound, which disables a low cost mass-production for the heat ray screening films. Japanese Patent NOs. JP06-262717, JP06-316439, JP06-257922, JP08-281860, JP09-108621 and JP09-151203, and U.S. Patent Publication NO. 2002/0090507 disclose methods of forming an organic solvent dispersion sol of an ATO water dispersion sol and an organic ATO (i.e., enhancing co-usability to an organic solvent by converting a hydrophilic surface of an ATO into a hydrophobic surface) and of forming heat ray screening coating films with respect to a hydrolic binder and an organic resin binder. However, the water ATO sol is insufficient in co-usability with an organic resin binder and the organic ATO sol is insufficient in co-usability with a hydrolic resin binder. Further, the organic ATO sol needs a secondary process to change the hydrophilic surface into the hydrophobic surface, which causes an increase in product cost.

### DISCLOSURE

### Technical Problem

In general, the solvents used for the dispersion of the functional nanoparticles include polar solvents such as water and alcohol and nonpolar organic solvents such as toluene and xylene. The dispersion sol formed when the polar solvents such as water and alcohol are used is not compatible with anti-hydrolic binder resin such that the dispersion sol cannot be used with respect to the anti-hydrolic binder resin. To the contrary, when the dispersion sol formed when the nonpolar solvents are used is not compatible with hydrolic binder resin such that the dispersion sol cannot be used with respect to the hydrolic binder resin. Therefore, in a conventional art, it is not possible to use one dispersion sol with respect to various binder resins. Since the surfaces of the functional nanoparticles are hydrophilic, when the functional nanoparticles are dispersed in the nonpolar organic solvent, it is necessary to perform an additional powder manufacturing process of changing the hydrophilic surfaces of the powders to be hydrophobic, which is disadvantageous in terms of time and cost.

Therefore, it is necessary to develop an improved coating film having excellent property for screening heat rays in a low price.

It is an object of the present invention to provide a method of forming functional films that can be mass-produced in a low price and compositions for functional films formed thereby.

### Technical Solution

In order to achieve the object of the present invention, there is provided a method of uniformly dispersing functional nanoparticles in an amphoteric solvent to form functional nanoparticle dispersion sol (amphoteric solvent dispersion sol). The functional nanoparticles refer to nanoparticles that constitute functional films. The functional nanoparticles include conductive nanoparticles, ferroelectric nanoparticles, dielectric and ferroelectric nanoparticles, metallic oxides, sulfides, boron compounds, nitrides, near-infrared screening dyestuffs, and two-component system, three-component system, and four-component system inorganic pigment compounds but are not limited to the above. The conductive nanoparticles used for forming heat ray screening films include tin oxide, indium oxide, zinc oxide, cadmium oxide, antimony doped tin oxide (ATO), indium doped tin oxide (ITO), antimony doped zinc oxide (AZO), fluorine doped tin oxide (FTO), and aluminum doped zinc oxide but are not limited to the above.

The magnetic and ferromagnetic nanoparticles used for forming magnetic films or ferromagnetic films include γ-Fe2O₃, Fe₃O₄, CO—FeOₓ, barium ferrite, α-Fe, Fe—CO, Fe—Ni, Fe—Co—Ni, Co, and Co—Ni.

The dielectric and ferroelectric nanoparticles used for forming dielectric films or ferroelectric films include magnesium titanate, barium titanate, strontium titanate, lead titanate, lead zirconium titanate (PZT), lead lanthanum zirconate titanate (PLZT), perovskite compound including lead, magnesium silicate base material.

The metallic oxides include FeO₃, Al₂O₃, TiO₂, TiO, ZnO, ZrO₂, and WO₃ but are not limited to the above.

The sulfides include SiO₂ and ZnS but are not limited to the above.

The boron compounds include LaB₆ but are not limited to the above.

The nitrides include TiN, SiN, WiN, and TaN but are not limited to the above.

The near infrared screening dyestuffs include pthalocyannine series, anthraquinone series, naphtoquinone series, cyanine series, naphtaloctannine series, condensed azo polymers, and pyrrol series but are not limited to the above.

The two-component system, three-component system, and four-component system inorganic pigment compounds include Yellow(Ti—Sb—Ni, Ti—Sb—Cr), Brown(Zn—Fe), Red(Zn—Fe—Cr), Green(Ti—Zn—Co—Ni, Co—Al—Cr—Ti), Blue(Co—Al, Co—Al—Cr), and Black(Cu—Cr—Mn, Cu—Mn—Fe) but are not limited to the above.

The functional films include a heat ray screening film, a near infrared screening film, a chrominance correcting film, a conductive film, a magnetic film, a ferromagnetic film, a dielectric film, a ferroelectric film, an electrochromic film, an electroluminescence film, an insulating film, a reflecting film, a reflection preventing film, a catalyst film, a photocatalyst film, a light selectively absorbing film, a hard film, and a heat resisting film but are not limited to the above.

The amphoteric solvents include ethylene glycol monomethyl ether, ethylene glycol monoethyl ether, ethylene glycol monopropyl ether, and ethylene glycol monobutyl ether but are not limited to the above.

The functional nanoparticles are in the range of 0.1 to 80 wt % and the amphoteric solvents are in the range of 20 to 99.9 wt %. It is preferable that the functional nanoparticles be in the range of 5 to 60 wt % and that the amphoteric solvents be in the range of 40 to 95 wt %. The diameter of the functional nanoparticles uniformly dispersed in the amphoteric solvent is about no more than 100 μm and is preferably no more than 1 μm. The diameter of the functional nanometers is preferably 10 to 100 nm and the diameter of no less than 60% of the entire particles is preferably within 100 nm. The particles whose diameter is no more than 200 nm are not scattered in the wavelength range of a visible ray region to maintain the functional films transparent.

In general, the solvents used for the dispersion of the functional nanoparticles include polar solvents such as water and alcohol and nonpolar organic solvents such as toluene and xylene. The dispersion sol formed when the polar solvents such as water and alcohol are used is not compatible with anti-hydrolic binder resin such that the dispersion sol cannot be used with respect to the anti-hydrolic binder resin. To the contrary, when the dispersion sol formed when the nonpolar solvents are used is not compatible with hydrolic binder resin such that the dispersion sol cannot be used with respect to the hydrolic binder resin. Therefore, in a conventional art, it is not possible to use one dispersion sol with respect to various binder resins. Since the surfaces of the functional nanoparticles are hydrophilic, when the functional nanoparticles are dispersed in the nonpolar organic solvent, it is necessary to perform an additional powder manufacturing process of changing the hydrophilic surfaces of the powders to be hydrophobic, which is disadvantageous in terms of time and cost.

### ADVANTAGEOUS EFFECTS

Therefore, according to the present invention, functional nanoparticles are dispersed in an amphoteric solvent to manufacture amphoteric solvent dispersion sol such that it is possible to mix the functional nanoparticles with all of the binder resins without performing a secondary manufacturing process of malting the surfaces of the functional nanoparticles hydrophobic.

When the functional nanoparticles are dispersed in the amphoteric solvent to form the amphoteric solvent dispersion sol, it is possible to add a surface charge conditioner or a dispersing agent or both the surface charge conditioner and the dispersing agent.

The surface charge conditioner includes organic acid, inorganic acid, and polymer acid but is not limited to the above. The organic acid includes acetic acid and glacial acetic acid but is not limited to the above. The inorganic acid includes hydrochloric acid, nitric acid, phosphoric acid, and sulfuric acid but is not limited to the above. The polymer acid includes polyacrylic acid but is not limited to the above. For example, when hydrochloric acid is used as the surface charge conditioner with respect to ATO including antimony of 10 wt %, it is possible to use acid of 5×10−⁴ to 3.5×10−³ g with respect to the functional nanoparticles of 1 g.

On the other hand, the dispersing agent makes the envelope of the functional nanoparticles thick to stabilize the functional nanoparticles. The dispersing agent may include a dispersing agent having amine, a dispersing agent having acid, and a neutral dispersing agent but is not limited to the above. The dispersing agent includes Anti-Terra-203, Anti-Terra-204, Anti-Terra-205, Anti-Terra-206, Anti-Terra-U, Anti-Terra-U100, Anti-Terra-U80, BYK-154, BYK-220S, BYK-P104, BYK-P104S, BYK-P105, BYK-9075, BYK-9076, BYK-9077, Byklumen, Disperbyk, Disperbyk-101, Disperbyk-102, Disperbyk-103, Disperbyk-106, Disperbyk-107, Disperbyk-108, Disperbyk-109, Disperbyk-110, Disperbyk-111, Disperbyk-112, Disperbyk-115, Disperbyk-116, Disperbyk-130, Disperbyk-140, Disperbyk-142, Disperbyk-160, Disperbyk-161, Disperbyk-162, Disperbyk-163, Disperbyk-164, Disperbyk-166, Disperbyk-167, Disperbyk-169, Disperbyk-170, Disperbyk-171, Disperbyk-174, Disperbyk-176, Disperbyk-180, Disperbyk-181, Disperbyk-182, Disperbyk-183, Disperbyk-184, Disperbyk-185, Disperbyk-187, Disperbyk-190, Disperbyk-191, Disperbyk-192, Disperbyk-2000, Disperbyk-2001, Disperbyk-2050, Disperbyk-2070, Disperbyk-2150, Lactimon, and Lactimon-WS (BYK Chemie GmbH). For example, the use amount of the dispersing agent is 1 to 30 wt % with respect to the functional nanoparticles. When the use amount of the dispersing agent is less than 1 wt %, viscosity and preservation stability deteriorate. When the use amount of the dispersing agent is larger than 30 wt %, the physical property of the coating film may deteriorate.

The surface charge conditioner and the dispersing agent improve the surface property of the functional nanoparticle dispersion sol formed when the functional nanoparticles are dispersed in the amphoteric solvent and let the functional nanoparticles be more effectively dispersed.

The surface charge conditioner lets the functional nanoparticles be easily dispersed by electrostatic repulsion. The functional nanoparticles in the dispersion sol (composition for the functional films) have charges on the surfaces thereof. The surface charge conditioner may strengthen the charge on the surface of the dispersion sol and make all of the nanoparticles have the same charge. Counter-ions surround the dispersion sol to form an electrical double layer. The dispersion sol is stabilized according as the electrical double layer becomes thicker.

The isoelectric point of the surfaces of the functional nanoparticles used for the present invention varies with the kind and state of the nanoparticles. pHiep=3.7 in the case of ATO and pHiep=8.5 in the case of ITO. Therefore, the respective suspensions are stable under the conditions in which pH>8 in the case of ATO and pH<6 in the case of ITO. The amount and kind of the surface charge conditioner used for dispersion vary with the composition, kind, and amount of the conductive nanoparticles. Therefore, it is preferable to determine the amount and kind of the surface charge conditioner used for dispersion in accordance with dispersion conditions. When hydrochloric acid is used for ATO that includes antimony of 10 wt % as the surface charge conditioner, it is possible to use acid of 5×10⁻⁴˜3.5×10⁻³ g with respect to the nanoparticles of 1 g.

The ITO nanoparticles have a high isoelectric point unlike the ATO nanoparticles. Therefore, the surface charge is determined in accordance with the purpose of use of the dispersion sol. When the dispersion sol of high density and low viscosity is manufactured, it is preferable to disperse the nanoparticles in the amphoteric solvent without controlling the surface charge and to apply the dispersing agent. The surface charge conditioner includes organic acid, inorganic acid, and polymer acid but is not limited to the above. The organic acid includes acetic acid and glacial acetic acid but is not limited to the above. The inorganic acid includes hydrochloric acid, nitric acid, phosphoric acid, and sulfuric acid but is not limited to the above. The polymer acid includes polyacrylic acid but is not limited to the above.

On the other hand, the dispersing agent lets the functional nanoparticles be easily dispersed due to steric hindrance. The dispersing agent that causes the steric hindrance has the following two structures.

First, the dispersing agent has one functional group or a plurality of functional groups that can be adhered to the surfaces of the conductive nanoparticles and that are affinitive to the conductive nanoparticles such that the dispersing agent is strongly and continuously adhered to the surface of dyestuff.

Second, the dispersing agent has compatible hydrocarbon entities such that the dispersing agent suspends the hydrocarbon entities to the amphoteric solvent around the conductive nanoparticles. Suspending the hydrocarbon entities to the amphoteric solvent and being adhered to the surfaces of the conductive nanoparticles is referred to as steric hindrance or entropic stabilization.

The polymer of the dispersing agent and the amphoteric solvent interact with each other to make the envelope around the conductive nanoparticles thick and to thus improve stability. The sol dispersed by the above-described stabilizing method may be used for both the anti-hydrolic resin binder and the hydrolic binder resin that uses part of the solvent. The dispersing agent helps the conductive nanoparticles to be directly dispersed in the amphoteric solvent or helps the conductive nanoparticles to be dispersed in the amphoteric solvent together with the surface charge conditioner. Therefore, the dispersing agent is adhered to the dispersion sol dispersed in the amphoteric solvent such that the distance between the nanoparticles is maintained uniform due to the electrostatic repulsion and the steric hindrance to prevent the nanoparticles from cohering and to thus deteriorate viscosity.

The nanoparticle dispersion sol formed according to the present invention is compatible with and stable in the hydrolic, alcoholic, and anti-hydrolic resin binders. Also, the composition for the functional films according to the present invention has excellent preservation stability.

In order to achieve the above object, there is provided a method of manufacturing functional films using the functional nanoparticle dispersion sol. In the method of manufacturing the functional films according to the present invention, the functional nanoparticle dispersion sol and the binder resin are uniformly mixed with each other using an agitator to form the composition for the functional films and then various films, plastic molds, or glasses are coated with the composition for the functional films.

The transparent various films, the plastic molds, or the glasses are coated with the composition for the functional films and are hardened to manufacture functional films such as a heat ray screening film, a near infrared screening film, a ceramic color tinting film, a chrominance correcting film, a conductive film, a magnetic film, a ferromagnetic film, a dielectric film, a ferroelectric film, an electrochromic film, an electroluminescence film, an insulating film, a reflecting film, a reflection preventing film, a catalyst film, a photocatalyst film, a light selectively absorbing film, a hard film, and a heat resisting film. A method of coating the various films, the plastic molds, or the glasses includes spin coating, deep coating, roll coating, bar coating, screen printing, gravure, microgravure, and offset and is not limited to the above.

The functional nanoparticle dispersion sol and the binder resin may be mixed with each other in the ratios of 97:3 to 30:70 but are preferably mixed with each other at the ratios of 95:5 to 70:30.

Though not restricted, the binder resins that can form films having excellent transparency are preferably used. When the binder resins are compatible with each other, it is possible to select one or two or more kinds of binder resins in accordance with hardening conditions such as thermohardening and ultraviolet hardening. The hydrolic binder resins include hydrolic emulsion type binder resin such as water-soluble alkyd, polyvinylalcohol, polybutylalcohol, acryl, acrylstyrene, and vinylacetate. The alcoholic binder resins include polyvinylbutyral and polyvinylacetal. The anti-hydrolic thermohardening binder resins include acryl, polycarbonate, polyvinylchloride, urethane, melamine, alkyd, polyester, and epoxy. The ultraviolet hardening resins include epoxy acrylate, polyether acrylate, polyesther acrylate, and urethane-metamorphosed acrylate.

The use amount of the binder resin is 1 to 95 wt % with respect to the composition for the functional films of 100 wt %, however, is preferably 5 to 40 wt %.

The functional film manufactured according to the present invention has a structure in which the functional nanoparticles are uniformly dispersed in the anti-hydrolic binder resin. The functional films have excellent property according as the amount of the used nanoparticles increases under the condition where the kind of materials, the kind of the functional nanoparticles, and additive are the same.

According to the method of manufacturing the functional films of the present invention, since the functional nanoparticles are dispersed in the amphoteric solvent, it is possible to perform hardening using ultraviolet ray and electron ray when the hydrolic and alcoholic binder resins as well as the organic binder resin are used. Furthermore, it is possible to manufacture the functional films by thermohardening and cold setting.

According to the method of manufacturing the functional films of the present invention, in order to expose the dispersion sol formed by dispersing the functional nanoparticles in the amphoteric solvent to chemical rays such as the ultraviolet ray and the electron ray such that the dispersion sol is easily hardened, photopolymerization initiator may be added. The photopolymerization initiators include 1-hydroxy-cyclo-hexyl-phenyl-ketone, benzyl-dimethyl-ketal, hydroxy-dimethyl-aceto-phenon, benzoin, benzoin-methyl-ether, benzoin-ethyl-ether, benzoin-isopropyl-ether, benzoin-buthyl-ether, benzyl, benzophenone, 2-hydroxy-2-methylpropiophenone, 2,2-dietoxy-ethophenone, anthraquinone, chloroanthraquinone, ethylanthraquinone, buthylanthraquinone, 2-chlorotioxanthone, alpha-chloromethylnaphthalene, and anthracene. To be specific, the photolymerization initiators include Lucirin (basf Co.), Darocur MBF, Igacure-184, Igacure-651, Igacure-819, and Igacure-2005 (Ciba Geigy Co.). One or more photopolymerization initiators may be mixed with each other. The ratio of the photopolymerization initiator is 0.1 to 10 wt % and is preferably 1 to 5 wt % with respect to the dispersion sol of 100 wt %.

### DESCRIPTION OF DRAWINGS

FIG. 1 illustrates light transmission spectrums of films containing the conductive nanoparticles ITO and ATO obtained by embodiment 1.

FIG. 2 illustrates a light transmission spectrum of a film containing a boron compound LaB₆ obtained by embodiment 2.

FIG. 3 illustrates light transmission spectrums of films containing multicomponent inorganic dyestuffs obtained by embodiment 3.

### BEST MODE

### Manufacturing of Functional Nanoparticles

### Example 1

### Manufacturing of Functional Nanoparticle Dispersion Sol Using Conductive Nanoparticles

After mixing ITO nanoparticles or ATO nanoparticles containing antimony (Sb) of 5, 10, 15, and 20 wt % of 40 to 130 g with amphoteric solvent of 70 to 160 g, zirconia balls whose diameter is 2 mm were charged up to 50 vol % and then dispersed in the mixed solution for 24 hours. After adding a surface charge conditioner as an additive thereto to control pH, dispersing agents, Anti-Terra-U, Disperbyk-163, and disperbyk-180 (BYK Chemie Co.) of 1 to 20 g were added thereto and uniformly mixed therewith by an agitator to manufacture high persormance ITO and ATO nanoparticle dispersion sol with good co-usability to hydrolic, alcoholic, and anti-hydrolic resin binders. In the case of mixing the ITO and ATO nanoparticles with an ultraviolet hardening resin binder, photopolymerization initiators, Lucirin (Basf Co.), Darocur MBF, Igacure-184, Igacure-651, Igacure-819, and Igacure-2005 (Ciba Geigy Co.) of 1 to 20 g were added thereto to manufacture the dispersion sol.

### MODE FOR INVENTION

### Example 2

### Manufacturing of Functional Nanoparticle Dispersion Sol Using Boron Compound

After mixing LaB₆ nanoparticles of 5 to 100 g with the amphoteric solvent of 100 to 195 g, zirconia balls whose diameter is 2 mm were charged up to 50 vol % and then dispersed in the mixed solution for 24 hours. After adding the surface charge conditioner as the additive thereto to control pH, dispersing agents, Anti-Terra-U, Disperbyk-163, and Byketol-WS (BYK Chemie Co.) of 1 to 20 g were added thereto and uniformly mixed therewith by the agitator to manufacture high persormance ITO nanoparticle dispersion sol with good co-usability to hydrolic, alcoholic, and anti-hydrolic resin binders. In the case of mixing the ITO nanoparticles with an ultraviolet hardening resin binder, the photopolymerization initiators, Lucirin (Basf Co.), Darocur MBF, Igacure-184, Igacure-651, Igacure-819, and Igacure-2005 (Ciba Geigy Co.) of 1 to 20 g were added thereto to manufacture the dispersion sol.

### Example 3

### Manufacturing of Functional Nanoparticle Dispersion Sol Using Inorganic Dyestuff Nanoparticles

After mixing blue, green, yellow, and orange inorganic nanoparticles of 5 to 100 g with the amphoteric solvent of 100 to 195 g, zirconia balls whose diameter is 2 mm were charged up to 50 vol % and then dispersed in the mixed solution for 24 hours. After controlling pH, dispersing agents, Anti-Terra-204, Disperbyk-181, and Disperbyk-2000 (BYK Chemie Co.) of 1 to 20 g were added thereto and uniformly mixed therewith by the agitator to manufacture high persormance ITO nanoparticle dispersion sol with good co-usability to hydrolic, alcoholic, and anti-hydrolic resin binders. In the case of mixing the ITO nanoparticles with an ultraviolet hardening resin binder, the photopolymerization initiators, Lucirin (Basf Co.), Darocur MBF, Igacure-184, Igacure-651, Igacure-819, and Igacure-2005 (Ciba Geigy Co.) of 1 to 20 g were added thereto to manufacture the dispersion sol.

### Example 4

### Manufacturing of Functional Films Using Functional Nanoparticles and Binder Resins

After controlling the volume ratio of functional nanoparticles to binder from 5:95 to 80:20 in the functional nanoparticle dispersion sol of the above embodiments 1, 2, and 3 and a hardening deposition film formed of acrylate series ultraviolet hardening resin, the functional nanoparticle dispersion sol and the hardening deposition film were uniformly mixed with each other using the agitator to manufacture a composition for the functional films, that is, ultraviolet hardening functional coating solution.

After coating a proper substrate such as a film, a panel, or glass formed of polyesther, polycarbonate series resin, poly(metha)acrylacidesther series resin, satured polyesther series resin, and cyclic olefin resin with a manufactured composition for functional films Meyer Rod #3 to 20 such that powder thickness is 0.1 to 10 μm, the substrate was dried by hot air such that the solvent is volatilized and was irradiated with a high-pressure mercury lamp of 100 W in a conveying velocity of 20 m/min such that the coating film was hardened to manufacture the functional film.

The following Table 1 illustrates results obtained by evaluating various functional films manufactured as described above.

TABLE 1
PROPERTIES OF FUNCTIONAL FILMS

| | Func- | | | | | | | | | | | | Preser- |
|---|---|---|---|---|---|---|---|---|---|---|---|---|---|
| | tional | | | | | | | | | | | Pencil | vation |
| | nano- | Sol- | | | | IR-C | Haze Meter | | | | Adhe- | inten- | stabi- |
| No. | particles' | vent | Acid | Rod # | VLT | 950 nm | L | a | b | Haze | sion | sity | lity |
| 1 | ITO | EGEE | HCl | 10 | 68 | 83 | 82.50 | −2.50 | −1.18 | 1.91 | ∘ | 2H | ∘ |
| | | | | | | | | | | | | ↑ | |
| 2 | ATO | EGPE | AcOH | 10 | 60 | 72 | 77.50 | −1.97 | −3.09 | 1.98 | ∘ | 2H | ∘ |
| | | | | | | | | | | | | ↑ | |
| 3 | LaB₆ | EGBE | HNO₃ | 10 | 65 | 87 | 79.15 | −8.56 | 11.01 | 1.97 | ∘ | 2H | ∘ |
| | | | | | | | | | | | | ↑ | |
| 4 | Green | EGBE | H₃PO₄ | 10 | 70 | 13 | 84.95 | −6.87 | 2.93 | 2.30 | ∘ | 2H | ∘ |
| | | | | | | | | | | | | ↑ | |
| 5 | Red | EGPE | HCl | 10 | 65 | 15 | 79.88 | 6.60 | 28.85 | 2.58 | ∘ | 2H | ∘ |
| | | | | | | | | | | | | ↑ | |
| 6 | Blue | EGBE | HCl | 10 | 51 | 13 | 77.72 | −0.48 | −16.93 | 2.14 | ∘ | 2H | ∘ |
| | | | | | | | | | | | | ↑ | |
| 7 | Yellow | EGME | HCl | 10 | 81 | 12 | 89.42 | −8.05 | 26.28 | 1.96 | ∘ | 2H | ∘ |
| | | | | | | | | | | | | ↑ | |
| 8 | TiO₂ | EGME | HCl | 10 | 81 | 12 | 89.69 | 0.75 | 4.20 | 2.11 | ∘ | 2.H | ∘ |
| | | | | | | | | | | | | ↑ | |

*EGME: Ethylene glycolmonomethyl ether,
EGEE: Ethylene glycol monoethyl ether,
EGPE: Ethylene glycol monopropyl ether,
EGBE: Ethylene glycol monobuthyl ether

As noted from TABLE 1, the functional films formed using the amphoteric solvent according to the present invention have various functions in accordance with the kind and property of used nanoparticles.

First, the specimens 1 and 2 have high visible ray transmittance and excellent heat ray screening effect and preservation stability.

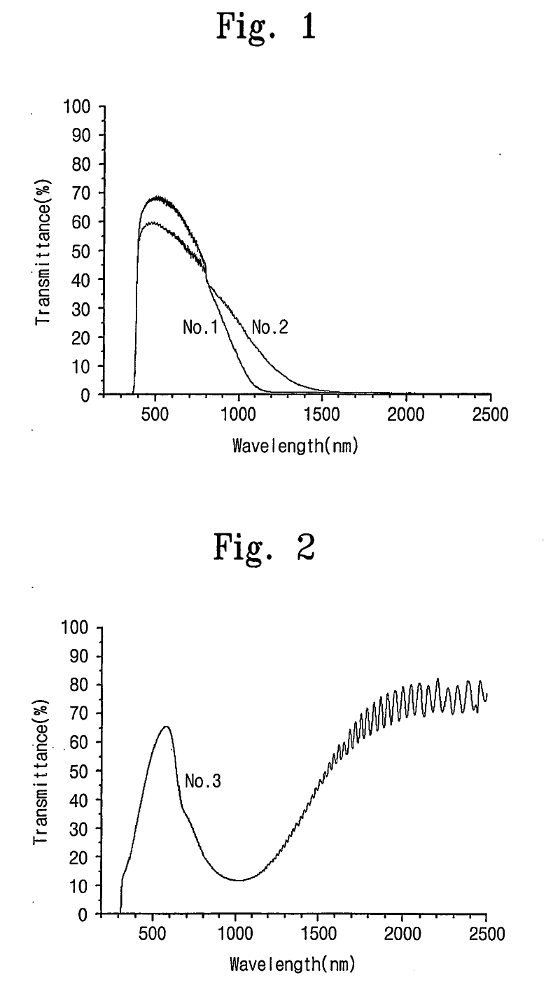

FIG. 1 illustrates light transmission spectrums of the specimens 1 and 2 in TABLE 1. As illustrated in FIG. 1, the specimens 1 and 2 have excellent heat ray screening and visible ray transmitting functions.

Second, the specimen 3 formed of boron compound nanoparticles has excellent near infrared screening effect.

FIG. 2 illustrates a light transmission spectrum of the specimen 3 in TABLE 1. As illustrated in FIG. 2, the specimen 3 has excellent near infrared screening and visible ray transmitting functions.

Third, the specimens 4 to 7 formed of multicomponent inorganic dyestuff nanoparticles have high visible ray transmittance, have various colors in accordance with the component and ratio of the nanoparticles, and have low haze values. That is, the specimens 4 to 7 have excellent ray selectively absorbing function.

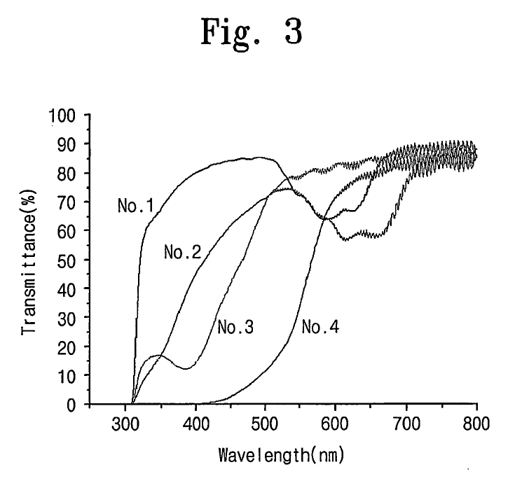

FIG. 3 illustrates light transmission spectrums of the specimens 4 to 7 in TABLE 1. As illustrated in FIG. 3, the specimens 4 to 7 have excellent visible ray transmitting function and various colors.

Fourth, the specimen 8 formed of TiO₂ nanoparticles has excellent preservation stability, high visible ray transmittance, and a low haze value. Therefore, the specimen 8 can be used as a coating film for photocatalyst.

When the functional nanoparticles are dispersed using the amphoteric solvent and the dispersing agent according to the present invention and acid, the dispersing property of the functional nanoparticles and the preservation stability of the functional coating solution are excellent. That is, according to the present invention, the co-usability of the coating solution manufactured using the amphoteric solvent is excellent regardless of the kind of binder resin. That is, it was possible to obtain similar results when acrylate series ultraviolet hardening resin was used. On the other hand, when nonpolar organic solvent such as toluene, xylene, and benzen and hydrochloric acid were used, the functional nanoparticles were not uniformly dispersed. When the functional nanoparticles are dispersed in the nonpolar organic solvent, an additional powder manufacturing process of changing the surfaces of powders to be hydrophobic is required when the surfaces of the functional nanoparticle powders are not hydrophobic.

### Example 5

After controlling the volume ratio of functional nanoparticles to binder from 15:85 to 80:20 in the functional nanoparticle dispersion sol of the above embodiments 1, 2, and 3 and a hardening deposition film formed of acrylate series thermohardening resin, the functional nanoparticle dispersion sol and the hardening deposition film were uniformly mixed with each other using the agitator to manufacture thermohardening heat ray screening coating solution.

### Example 6

After mixing the functional nanoparticle dispersion sol of the embodiments 1, 2, and 3 with cold setting binder resin manufactured by dissolving polyvinylalcohol (PVA) in distilled water or alcohol, the functional nanoparticle dispersion sol and the binder resin were uniformly mixed with each other to manufacture cold setting heat ray screening coating solution.

### INDUSTRIAL APPLICABILITY

According to the present invention, there is provided functional films such as a heat ray screening film, a near infrared screening film, ceramic color tinting films, a chrominance correcting film, a conductive film, a magnetic film, a ferromagnetic film, a dielectric film, a ferroelectric film, an electrochromic film, an electroluminescence film, an insulating film, a reflecting film, a reflection preventing film, a catalyst film, a photocatalyst film, a light selectively absorbing film, a hard film, and a heat resisting film.

1. A composition for functional films comprising functional nanoparticles uniformly dispersed in amphoteric solvent.

2. The composition for functional films as claimed in claim 1, wherein the functional nanoparticles comprise conductive nanoparticles, ferroelectric nanoparticles, dielectric and ferroelectric nanoparticles, metallic oxides, sulfides, boron compounds, nitrides, near-infrared screening dyestuffs, and two-component system, three-component system, and four-component system inorganic pigment compounds.

3. The composition for functional films as claimed in claim 1, wherein the functional nanoparticles are in the range of 0.1 to 80 wt %; and wherein the amphoteric solvent is in the range of 20 to 99.9 wt %.

4. The composition for functional films as claimed in claim 3, wherein the amphoteric solvent comprises ethylene glycol monomethyl ether, ethylene glycol monoethyl ether, ethylene glycol monopropyl ether, and ethylene glycol monobutyl ether.

5. The composition for functional films as claimed in claim 1, further comprising acid for controlling the surface charge of the functional nanoparticles, wherein the acid comprises organic acid, inorganic acid, and polymer acid.

6. The composition for functional films as claimed in claim 1, further comprising dispersing agent for stabilizing the functional nanoparticles.

7. The composition for functional films as claimed in claim 6, wherein the dispersing agent is in the range of 1 to 30 wt % with respect to the functional nanoparticles, and
wherein the dispersing agent comprises a dispersing agent having amine, a dispersing agent having acid, and a neutral dispersing agent.

8. The composition for functional films as claimed in claim 7, further comprising one or more binder resins among anti-hydrolic binder resin, hydrolic binder resin, and alcoholic binder resin.

9. The composition for functional films as claimed in claim 8, wherein the binder resin is in the range of 3 to 70 wt %.

10. The composition for functional films as claimed in claim 9, wherein the hydrolic binder resin comprises water-soluble alkyd, polyvinylalcohol, polybutylalcohol, acryl, acrylstyrene, and vinylacetate,
wherein the alcoholic binder resin comprises polyvinylbutyral and polyvinylacetal, and wherein the anti-hydrolic binder resin comprises thermohardening binder resin including acryl, polycarbonate, polyvinylchloride, urethane, melamine, alkyd, polyester, and epoxy and ultraviolet hardening binder resin including epoxy acrylate, polyether acrylate, polyesther acrylate, and urethane-metamorphosed acrylate.

11. The composition for functional films as claimed in claim 8, further comprising photopolymerization initiator including 1-hydroxy-cyclo-hexyl-phenyl-ltetone, benzyl-dimethyl-ltetal, hydroxy-dimethyl-aceto-phenon, benzoin, benzoin-methyl-ether, benzoin-ethyl-ether, benzoin-isopropyl-ether, benzoin-buthyl-ether, benzyl, benzophenone, 2-hydroxy-2-methylpropiophenone, 2,2-dietoxy-ethophenone, antluaquinone, chloroanthraquinone, ethylanthraquinone, buthylanthraquinone, 2-chlorotioxanthone, alpha-chloromethylnaphthalene, and anthracene.

12. The composition for functional films as claimed in claim 8, wherein the functional nanoparticles have a diameter of no more than 200 nm and are in the range of 5 to 70 wt %, and
wherein the amphoteric solvent is in the range of 30 to 95 wt %.

13. The composition for functional films as claimed in claim 12, wherein the amphoteric solvent comprises ethylene glycol monomethyl ether, ethylene glycol monoethyl ether, ethylene glycol monopropyl ether, and ethylene glycol monobutyl ether.

14. A method of forming a composition for functional films, wherein functional nanoparticles are uniformly dispersed in amphoteric solvent.

15. The method as claimed in claim 14, wherein the nanoparticles are dispersed in the amphoteric solvent such that the functional nanoparticles have a diameter of no more than 200 nm and are in the range of 5 to 70 wt % and that the amphoteric solvent is in the range of 30 to 95 wt %.

16. The method as claimed in claim 14, wherein the functional nanoparticles are dispersed in the amphoteric solvent using dispersing agent and one or more among acids for controlling the surface charge of the conductive nanoparticles.

17. The method as claimed in claim 16,
wherein the functional nanoparticles are ATO nanoparticles containing Sb of 5 to 20 wt %,
wherein the amount of the acid is in the range of 5×10−⁴ to 3.5×10−³ g,
wherein the amount of the dispersing agent is 1 to 30 wt % with respect to the conductive nanoparticles, and
wherein the dispersing agent comprises a dispersing agent having amine, a dispersing agent having acid, and a neutral dispersing agent.

18. A method of forming functional films using the composition as claimed in claim 16, comprising the steps of:
mixing functional nanoparticles with one or more binder resins among anti-hydrolic binder resin, hydrolic binder resin, and alcoholic binder resin to form coating solution;
coating a substrate with the coating solution; and
hardening the substrate using chemical rays such as ultraviolet ray and electron ray or heat.

19. The method as claimed in claim 18, wherein the binder resin is in the range of 3 to 70 wt %.

20. The method as claimed in claim 18, wherein the substrate is a film, a panel, or glass formed of polyesther, polycarbonate series resin, poly(metha)acrylacidesther series resin, satured polyesther series resin, and cyclic olefin resin and is hardened by ultraviolet ray.

21. A functional film manufactured by the method as claimed in claim 16.

22. A functional film manufactured by the method as claimed in claim 18.
